(19) United States
(12) Patent Application Publication
(10) Pub. No.: US 2026/0365213 A1
(43) Pub. Date: Nov. 19, 2026

(54) Multi-Modal Container Transporter

(71) Applicant: KAPROCK MANAGEMENT LLC, Grapevine, TX (US)

(72) Inventors: Noah Michael Rodebaugh, Lake Forest, CA (US); Dylan Tyler Ritchie, Carlsbad, CA (US); Matthew Eaton Davis, Rancho Santa Margarita, CA (US); Timothy Michael Case, Mission Viejo, CA (US)

(73) Assignee: KAPROCK MANAGEMENT LLC, Grapevine, TX (US)

(21) Appl. No.: 19/733,650

(22) Filed: Jul. 7, 2026

Related U.S. Application Data
(63) Continuation-in-part of application No. 30/003,944, filed on May 15, 2025.
(60) Provisional application No. 63/840,402, filed on Jul. 8, 2025.

(51) Int. Cl. B62B 3/02; B62B 3/00; B62B 3/10; B62B 5/06

(52) U.S. Cl. CPC B62B 3/02; B62B 3/002; B62B 3/10; B62B 5/065; B62B 2207/02

(57) ABSTRACT

A container transport system relates to modular transporters configured to support containers. In an illustrative example, a first transporter and a second transporter each include a receiver having a recess cavity and a connector cavity, with the recess cavity extending along a first path and the connector cavity extending along a second path intersecting the first path. For example, a U-type coupler connector may include a bridge linking two downward-extending inserts configured for top-insertion from above the transporters into the connector cavities. The bridge may, for example, be positioned within the recess cavities such that an uppermost surface of the connector is flush or sub-flush with a top surface of the transporters. Various embodiments may advantageously provide expandable and customizable transportation solutions for moving multiple stacks of containers as a unified assembly.

### CROSS-REFERENCE TO RELATED APPLICATIONS

This application claims the benefit of U.S. provisional patent application Ser. No. 63/840,402, filed Jul. 8, 2025, and titled “Multi-modal Container Transporter.” The entire contents of the referenced application is incorporated herein by reference.

This application is a Continuation-in-Part of and claims the benefit of U.S. design patent application Ser. No. 30/003,944, filed May 15, 2025 (naming inventor(s) including RODEBAUGH, Noah Michael) and titled “Container Transporter.” The entire contents of the referenced application is incorporated herein by reference.

Unless expressly stated, changes in terminology from priority application(s) to this application are made without prejudice or disclaimer of subject matter. Changes from the priority application(s) (e.g., provisional applications(s)) are intended to be broadening and/or additive unless expressly stated otherwise. Replacement of alternative terms with a single representative term, for example, are inclusive unless otherwise defined. Various embodiments may also be found in previous disclosure(s) incorporated by reference. Embodiments of similar languages in this application are not modifications or disclaimer of the embodiments disclosed in previous incorporated disclosures unless otherwise stated.

### BACKGROUND

Storage solutions are utilized in a variety of settings to organize and manage items efficiently. In residential environments, storage systems may be employed to declutter living spaces and maintain order. In commercial and industrial settings, storage solutions may facilitate inventory management and streamline operations. Storage systems may also be used in educational institutions to organize supplies and equipment, enhancing accessibility and efficiency. The use of storage solutions may, for example, improve space utilization and provide easy access to stored items.

There are numerous methods for storing items, each which may offer various advantages. Shelving units may, for example, provide vertical storage space, maximizing floor area usage. Cabinets and drawers may offer enclosed storage, protecting items from dust and damage. In some examples, mobile storage units may be used to transport items within a facility, enhancing flexibility and convenience. Storage bins and boxes may, for example, provide a modular approach to organizing items, allowing for easy categorization and retrieval. Each storage method may be selected based on specific needs and environmental considerations.

Stackable containers may, for example, offer a versatile solution for maximizing storage space. These containers may be designed to nest securely on top of one another, allowing for efficient use of vertical space. In some embodiments, stackable containers may include interlocking features to enhance stability during stacking. The use of stackable containers may, for example, facilitate easy reconfiguration of storage layouts, adapting to changing storage requirements. Stackable containers may be particularly advantageous in environments where space is limited, providing a compact and organized storage solution.

### TECHNICAL FIELD

Apparatus and methods generally relate to container transport.

### BRIEF SUMMARY

Apparatus and related methods relate to modular carts that join together to move stacks of containers as a single unit. In an illustrative embodiment, a first cart and a second cart each hold a container. For example, each cart includes a receiver having an upper pocket and a downward opening that meet where they cross. For example, a U-shaped joiner has a top bar linking two legs that drop from above into the downward openings. For example, the top bar settles into the upper pockets so the joiner sits level with or below the top of each cart. Various embodiments may advantageously provide expandable, customizable transport that moves several container stacks together while resisting misalignment and avoiding snagging.

Apparatus and related methods relate to a handle that attaches to a wheeled cart carrying a stack of storage bins. In an illustrative embodiment, a frame reaches from a lower end to an upper grip. For example, an attachment piece at the lower end includes a lower catch that hooks beneath the underside of the cart. For example, the attachment piece may include an upper catch that reaches over the top surface of the cart, so forces at the grip pass into the cart. For example, a fastener holds the attachment piece to the cart. Various embodiments may advantageously transfer steering and pulling forces directly into the cart for improved control while allowing the handle to be added, removed, or folded.

Various embodiments may advantageously enable multiple stacks of containers to be moved as a single unit, such as by rigidly coupling adjacent transporters into a train. Some embodiments may advantageously improve operational efficiency, such as by reducing the number of trips required to relocate multiple container stacks. Various embodiments may advantageously provide expandable and customizable transportation, such as by field-assembling transporters into linear, L-shaped, rectangular, grid, or other multi-axis arrays. Some embodiments may advantageously adapt a transport system to spatial constraints, such as by reconfiguring the array to fit through narrow doorways or aisles. Certain embodiments may advantageously reduce an overall height of the transport system, such as by adjusting array configuration for environments with low ceilings or overhead obstructions.

Some embodiments may advantageously reduce the risk of snagging or catching on external objects during transport, such as by positioning a connector flush or sub-flush with a top surface of a transporter. Various embodiments may advantageously enhance maneuverability and handling, such as by providing a smooth and uninterrupted surface across coupled transporters. Certain embodiments may advantageously resist relative rotation, yaw, twisting, racking, angular misalignment, or lateral offset between coupled transporters, such as by laterally constraining a bridge between opposing bearing surfaces. Some embodiments may advantageously maintain a target alignment of coupled transporters during pushing, pulling, turning, or crossing uneven surfaces, such as by limiting skew between adjacent transporters. Various embodiments may advantageously distribute forces between coupled transporters, such as by transferring shear, lateral, pulling, pushing, or turning loads through insert-and-cavity engagement.

Some embodiments may advantageously simplify assembly, such as by permitting top-insertion of a connector without requiring access to an underside of a transporter. Various embodiments may advantageously permit coupling, uncoupling, and reconfiguration without disturbing supported containers, such as by installing and removing a connector from above while wheels remain on a ground surface. Certain embodiments may advantageously allow rapid reconfiguration of a transport system, such as by using a separate, removable connector installable into different pairs of receivers. Some embodiments may advantageously enhance stability during transport, such as by distributing load across multiple linked transporters. Various embodiments may advantageously extend operational lifespan, such as by reducing strain on individual transporters through weight distribution across an array.

Some embodiments may advantageously reduce the weight or material of a transporter, such as by incorporating apertures or weight-reducing features. Various embodiments may advantageously improve moldability, such as by shaping cavities and walls for injection molding. Certain embodiments may advantageously improve tensile strength and reduce bending under load, such as by chamfering previously squared corner regions to redirect load paths through tensile or diagonal structural portions. Some embodiments may advantageously enhance load-bearing capacity, such as by reinforcing a framework with integral ribs. Various embodiments may advantageously secure containers against shifting during transport, such as by cooperating upper and lower cavities that resist movement of a container relative to the transporter.

Some embodiments may advantageously transfer steering and pulling forces directly into a transporter for improved control, such as by clamping a coupler over an upper surface and beneath an underside of the transporter. Various embodiments may advantageously improve maneuverability under heavy loads or on rough surfaces, such as by mounting a handle near a corner to apply turning forces that assist caster reorientation. Certain embodiments may advantageously increase steering rigidity, such as by distributing turning forces across a width of the transporter through a full-width handle connection. Some embodiments may advantageously improve lateral stiffness and load control, such as by employing spaced upright members in a two-post configuration. Various embodiments may advantageously accommodate user ergonomics and varying transporter or array widths, such as by providing telescoping members, expansion inserts, or interchangeable grips. Certain embodiments may advantageously facilitate compact storage and reduce a transport profile, such as by folding a handle flat against or alongside the transporter. Some embodiments may advantageously allow retrofit of an existing handle to a transporter, such as by adapting a commercially available telescoping handle with a custom bracket without modifying the transporter body.

Other embodiments and advantages are disclosed herein, including in the detailed description and the drawings.

### BRIEF DESCRIPTION OF THE DRAWINGS

Various embodiments of the present embodiments are described with reference to the following figures.

FIG. 1 is a perspective view of a container transport assembly.

FIG. 2A depicts an example container transport.

FIG. 2B is a top plan view of a transporter.

FIG. 2C is a bottom plan view of a transporter.

FIG. 2D is a side elevation view of a transporter.

FIG. 2E is an opposing side elevation view of a transporter.

FIG. 2F is an end elevation view of a transporter.

FIG. 2G is an opposing end elevation view of a transporter.

FIG. 3 depicts an example transport connector.

FIG. 4 depicts a cross-section of an example transport configuration.

FIG. 5 and FIG. 6 depicts perspective views of an example transport.

FIG. 7 depicts an example multi-axis modular transport array.

FIG. 8, FIG. 9, FIG. 10, FIG. 11, FIG. 12, FIG. 13, FIG. 14, and FIG. 15 depict example embodiments related to transport handles.

FIG. 16 depicts a container on a transporter with a handle.

FIG. 17 depicts a detail view of a coupler.

FIG. 18 depicts a detail view of a handle attachment to a transporter.

FIG. 19 depicts a detail view of a coupler hook mechanism.

FIG. 20 depicts a folding handle configuration.

Like reference numerals refer to like parts throughout the various views unless otherwise specified. Embodiments and portions of embodiments illustrated and described herein are non-limiting and non-exhaustive.

### DETAILED DESCRIPTION

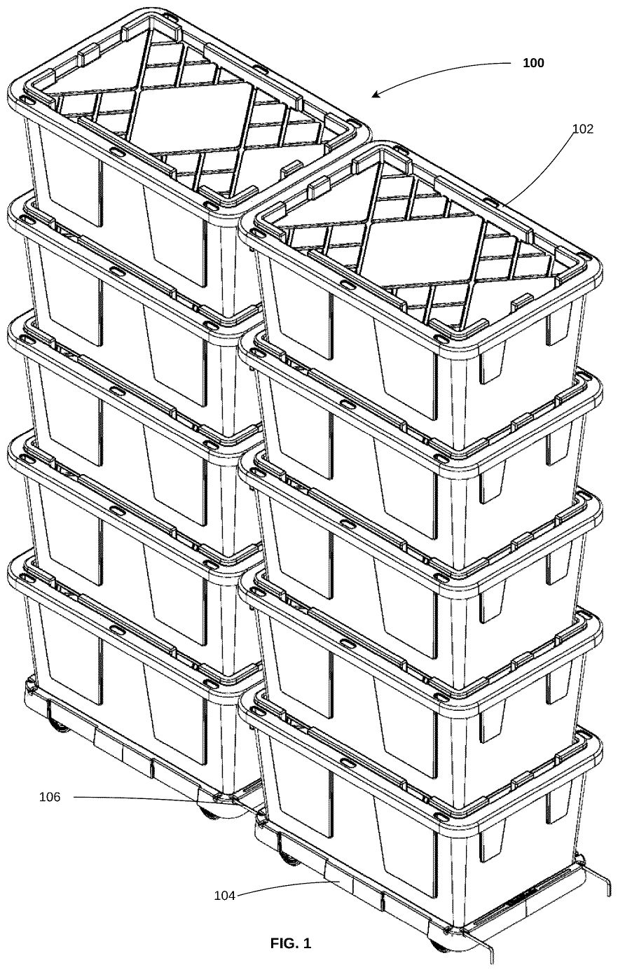

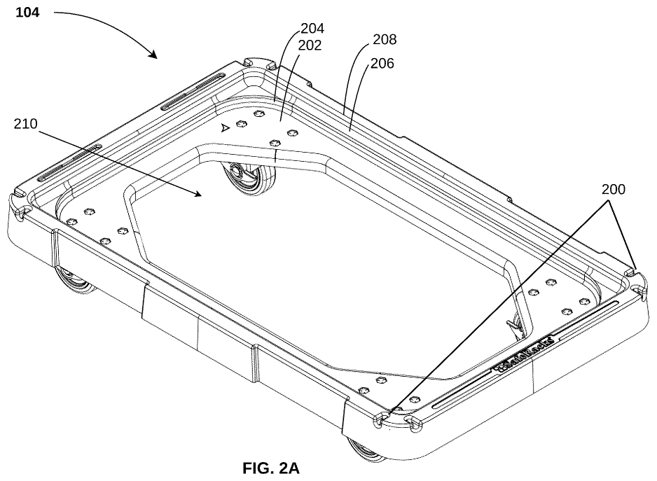

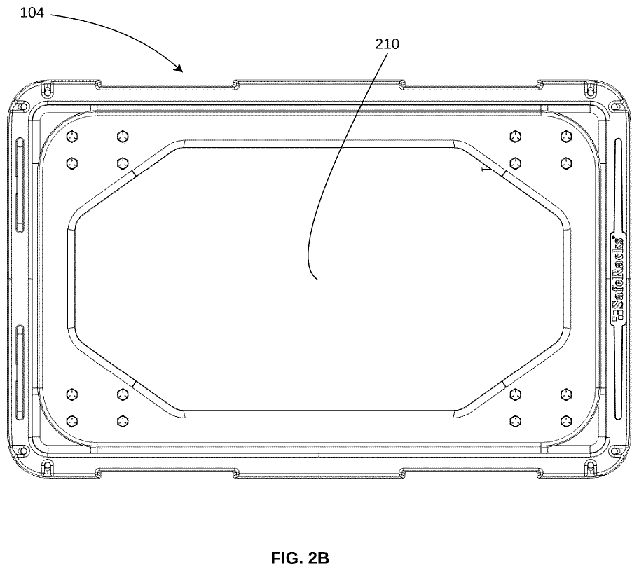

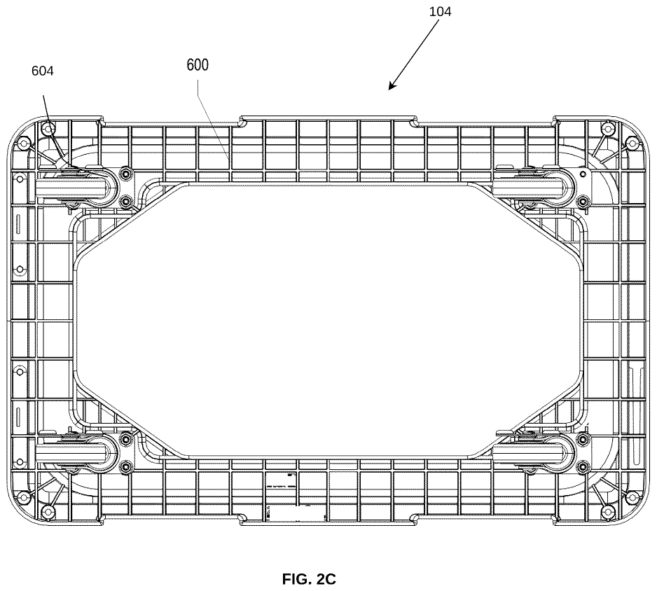

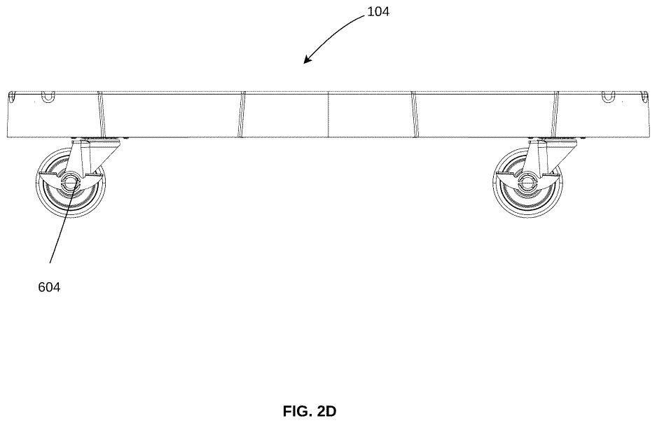

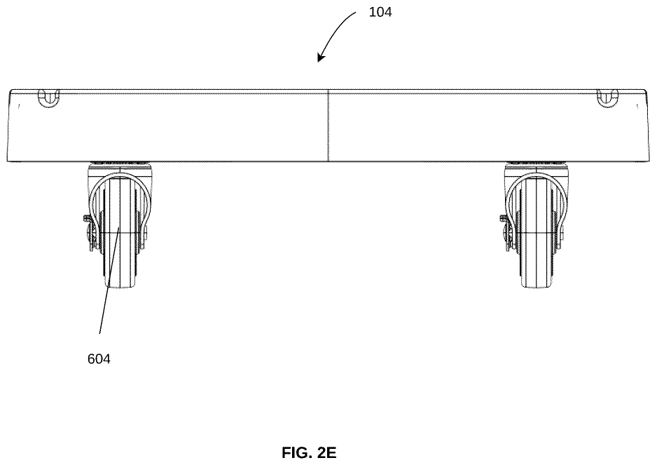

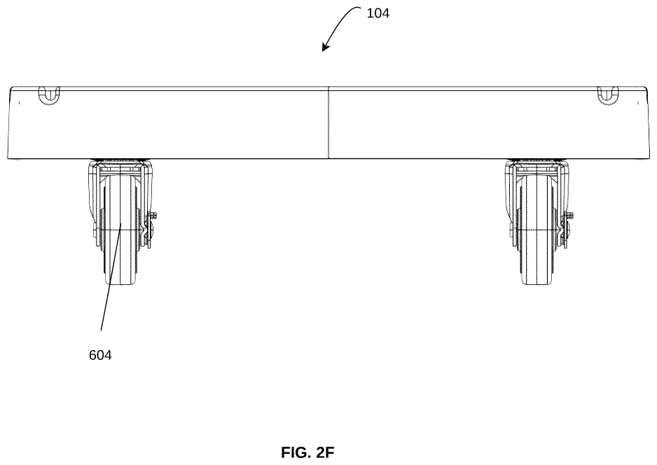

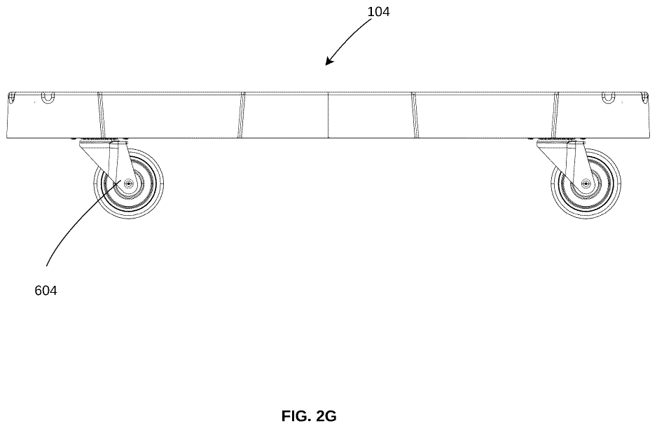

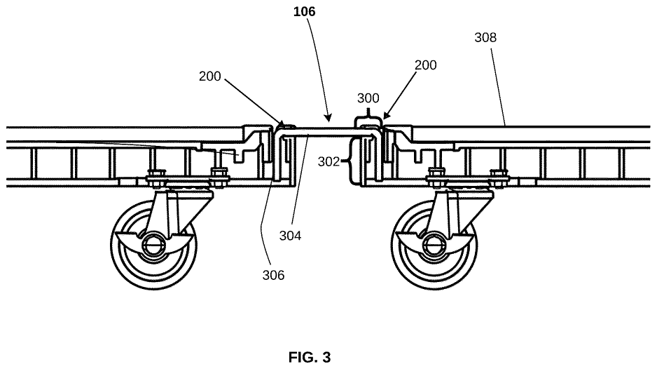

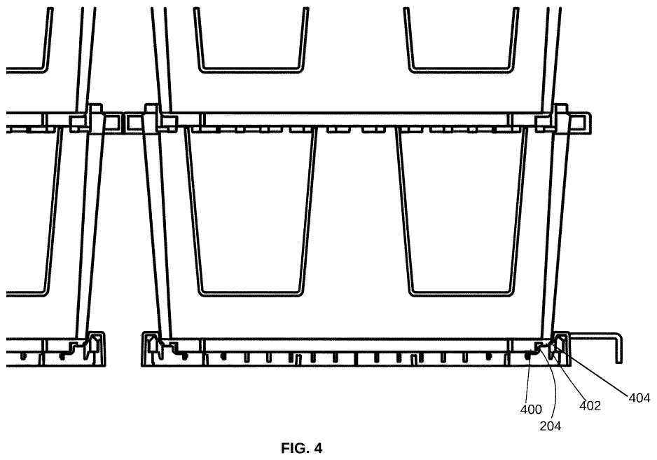

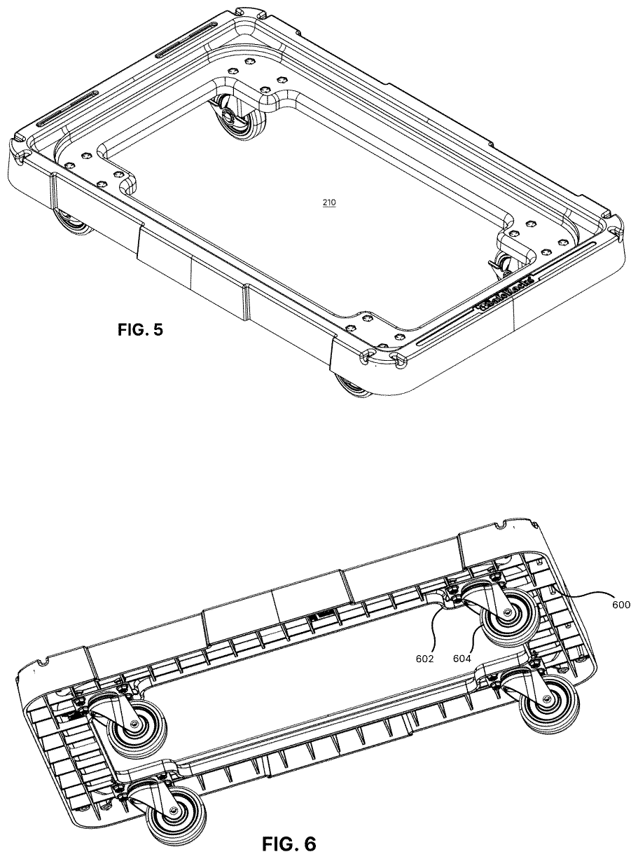

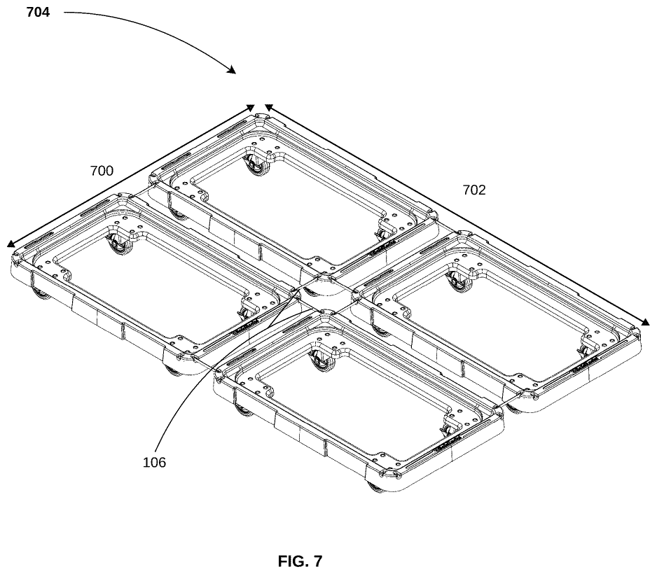

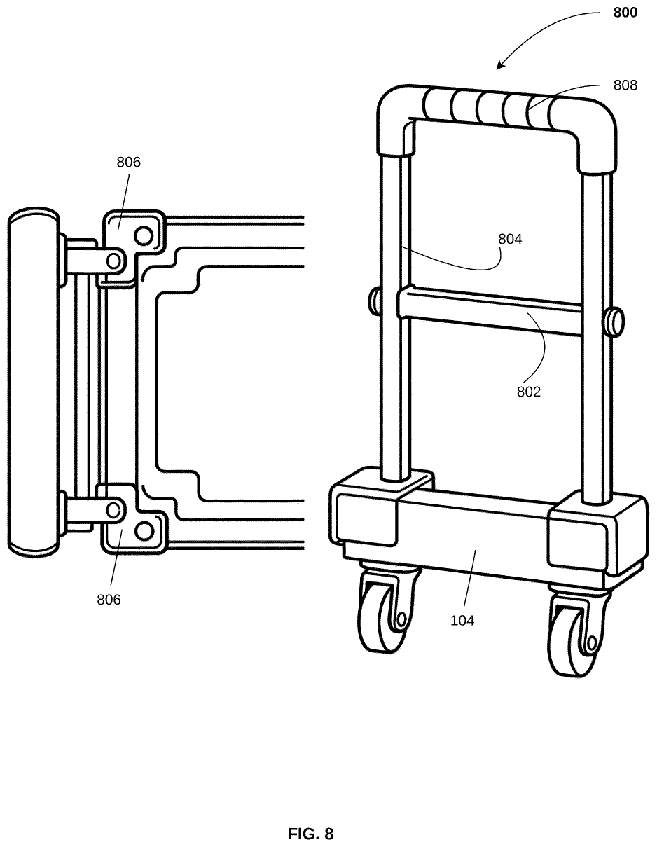

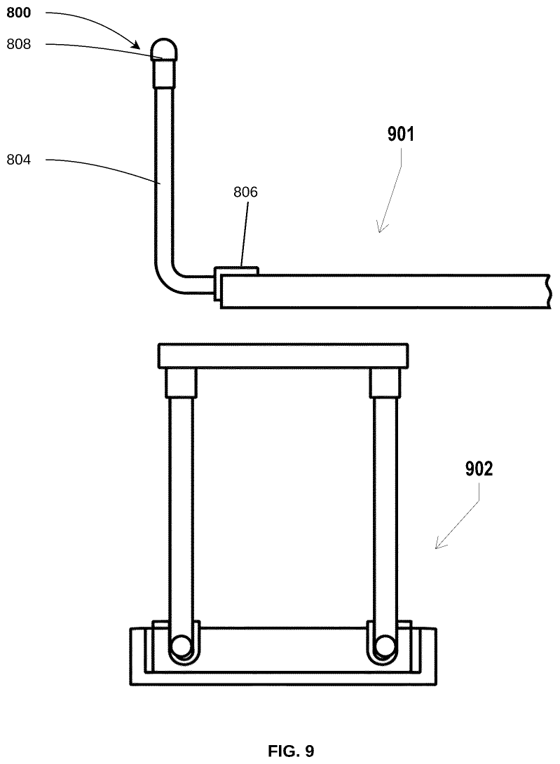

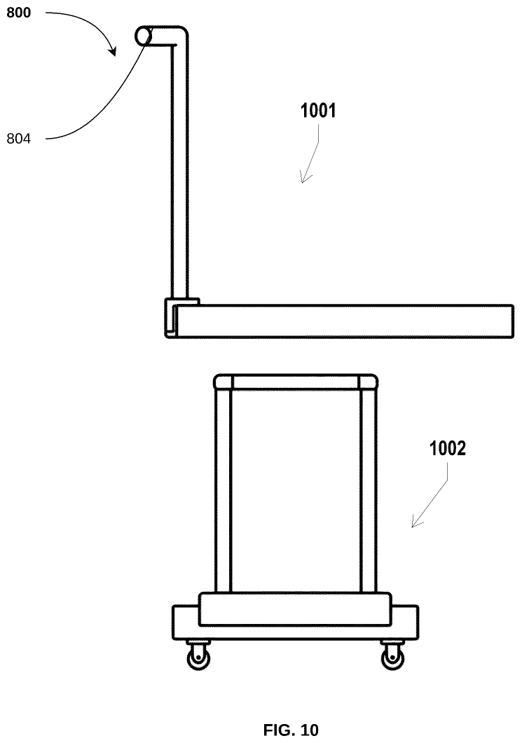

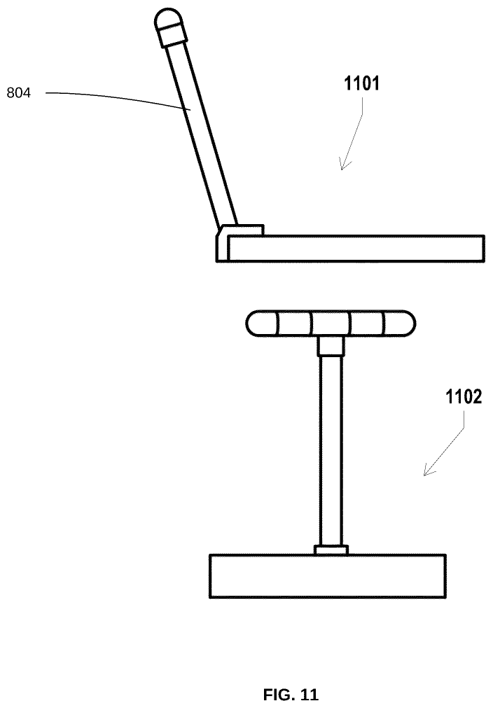

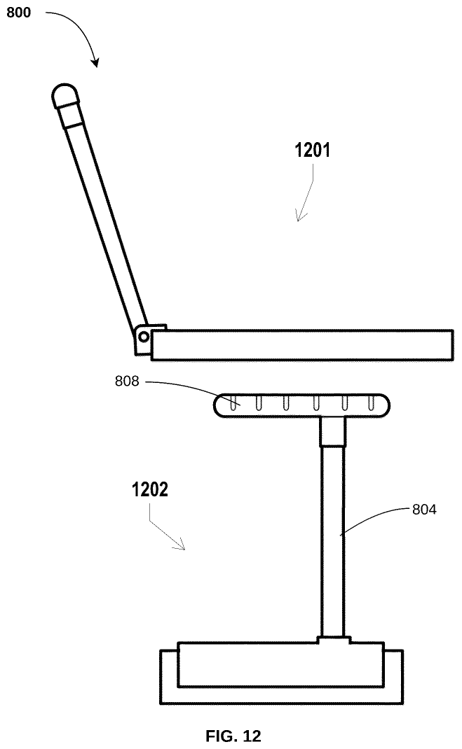

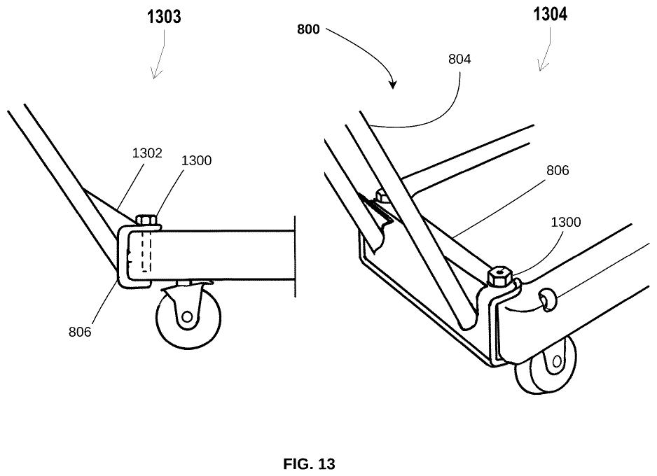

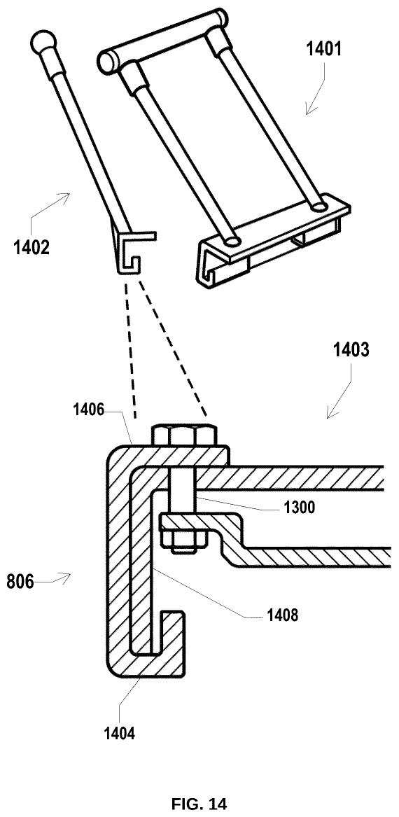

In order to assist rapid comprehension, this document introduces a container transport assembly in FIGS. 1 and 2A-2G. Methods related to configuration and/or operation of a receiver 200 and a connector 106 are described with respect to FIGS. 3 and 4. The discussion turns to structural features of the transporter, including ribs, wheel supports, and wheels, with reference to FIGS. 5 and 6. Then, example multi-axis transport arrays formed from multiple transporters joined by connectors are disclosed with respect to FIG. 7. Finally, various embodiments and/or features are discussed related to handle systems, including couplers, frames, grips, folding configurations, and telescoping members, including with respect to FIGS. 8-20.

FIG. 1 shows a container transport assembly 100. The container transport assembly 100 includes a container 102. The container 102 is positioned on a transporter 104. The transporter 104 is connected to adjacent transporter 104 via a connector 106.

The connector 106 may, for example, connect multiple transporters 104 together. In some embodiments, the transporter 104 may include a modular connectivity feature, such as a through-hole design with specialized notches. This may allow for expandable and customizable transportation solutions, providing flexibility in forming a single modular transporter array.

Stackable containers may, for example, present challenges related to stability during transport. In some instances, the containers may shift or topple, which may result in damage to the contents. The transporter 104 may, for example, advantageously facilitate relocation one or more stacks of container 102.

In some examples, such as shown, the transporter 104 may include wheels and/or other mobility-enhancing features. These features may advantageously allow for easy maneuverability of the container transport assembly 100 in various environments.

Field-assembly of a unified array of transporters, such as shown in FIG. 1 and/or disclosed at least with reference to a multi-axis transport array 704, may, for example, provide one or more advantages. In some embodiments, the ability to modify the configuration of the transporters may, for example, advantageously allow the array to fit through narrow doorways or aisles. This adaptability may, for example, enhance the usability of the system in environments with spatial constraints.

In some examples, the unified array of transporters may facilitate the movement of multiple stacks of containers (e.g., boxes, bins) simultaneously. This capability may, for example, improve operational efficiency by reducing the number of trips required to transport items. The ability to move multiple stacks may, for example, be advantageous in warehouse or retail settings where time and resource optimization are priorities.

The field-assembled array may, for example, allow for adjustments in height. This feature may, for example, enable the reduction of the overall height of the transport system, which may be beneficial in environments with low ceilings or overhead obstructions. Reducing the height may, for example, enhance the safety and maneuverability of the transporters during operation.

In some embodiments, the modular nature of the field-assembled array may, for example, provide flexibility in configuring the transport system to accommodate varying storage needs. This flexibility may, for example, allow users to adapt the system to different spatial constraints or organizational requirements, which may enhance the overall functionality and efficiency of the storage and transport solution.

FIG. 2A depicts an example container transport. As shown, the transporter 104 includes receivers 200. The receivers 200 are configured to receive the connectors 106, as shown in FIG. 7. In some embodiments, the receivers 200 may facilitate the coupling of multiple transporters 104 together. This configuration may, for example, enhance the transport capacity of the assembly.

In this example, the transporter 104 includes a lower cavity 202. The lower cavity 202 may be configured to accommodate a container 102, for example. The lower cavity 202. The transporter 104 is shown including an inner wall 204. The inner wall 204 may, for example, define the boundaries of the lower cavity 202.

In some embodiments the lower cavity 202 and/or inner wall 204 may, for example, be configured in decorative arrangements. In some examples, the lower cavity 202 may include a smooth shape. This configuration may, for example, provide a visually appealing design while maintaining functionality.

An upper cavity 206 is, in this example, positioned above the lower cavity 202 within the transporter 104. The upper cavity 206 may, for example, be configured to resist movement of a container 102 relative to the transporter 104. The upper cavity 206 and/or lower cavity 202 may, for example, advantageously assist in holding storage bins securely. This configuration may, for example, prevent the bins from shifting during transport, which may enhance the stability of the system.

In some embodiments the upper cavity 206 and/or outer wall 208 may, for example, be configured in decorative arrangements. In some examples, the upper cavity 206 may include a smooth shape. This configuration may, for example, provide a visually appealing design while maintaining functionality.

The transporter 104 may also include an outer wall 208. The outer wall 208 may encompass the upper cavity 206. In some examples, the outer wall 208 may provide additional structural integrity to the transporter 104, which may be advantageous in maintaining the overall shape and function of the system.

In some embodiments, such as depicted, the transporter 104 includes an aperture 210. The aperture 210 may, for example, reduce the weight of the transporter 104. In some embodiments, the aperture 210 may reduce the amount of material required for the transporter 104. The aperture 210 may, for example, increase the moldability of the transporter 104. In some examples, the aperture 210 may allow for easy grabbing of the transporter 104. The aperture 210 may, for example, facilitate handling of the transporter 104.

FIG. 2B is a top plan view of the transporter 104. As shown, the transporter 104 includes receivers 200 positioned along the upper edges of the frame. The outer wall 208 bounds the upper cavity 206, and the aperture 210 is positioned within a central region of the frame.

FIG. 2C is a bottom plan view of the transporter 104. The underside of the transporter 104 includes ribs 600 extending across the bottom surface. Wheel supports 602 are positioned at the corners of the frame, and wheels 604 are mounted to the wheel supports 602.

FIG. 2D is a side elevation view of the transporter 104. The transporter 104 includes a horizontal frame body with the outer wall 208 and wheels 604 mounted at the corners.

FIG. 2E is an opposing side elevation view of the transporter 104. The transporter 104 includes a horizontal frame body with the outer wall 208 and wheels 604 mounted at the corners.

FIG. 2F is an end elevation view of the transporter 104. The transporter 104 includes a horizontal frame body with the outer wall 208 and wheels 604 mounted at the corners.

FIG. 2G is an opposing end elevation view of the transporter 104. The transporter 104 includes a horizontal frame body with the outer wall 208 and wheels 604 mounted at the corners.

FIG. 3 depicts an example transport connector. The connector 106 may, for example, be a structural element that may facilitate the attachment of different components within the system. As shown, the connector 106 may be configured to engage with corresponding receivers 200 of transporters 104. The transporters 104 may, for example, provide a secure connection between transporter 104 (e.g., into a single assembly). The joined transporters 104 may, for example, advantageously create an assembled multi-container-stack transporter that moves, for example, as a single transporter.

In some embodiments, the connector 106 may be configured as a U-type coupler. The U-type coupler may, for example, include a bridge 304 connecting two downward-extending inserts 306. The inserts 306 may, for example, be configured for top-insertion from above the transporter 104 into the connector cavities 302. This top-insertion method may, for example, allow for convenient assembly of the connector 106 without requiring access to the underside of the transporter 104. The U-shaped configuration of the connector 106 may, for example, provide a secure mechanical connection between adjacent transporters 104.

The connector 106 may, as shown, include a bridge 304 linking inserts 306. In this example, the receiver 200 includes a recess cavity 300 and a connector cavity 302. The connector cavity 302 of the receiver 200 may, for example, be configured to receive an insert 306. The recess cavity 300 may, for example, be configured such that an uppermost surface of the connector 106, when installed, is flush or sub-flush to a top surface 308 of the transporter 104.

The recess cavity 300 may, for example, extend along a first path. In some examples, this first path may be aligned with a horizontal axis. The first path may, for example, intersect a second path. In some embodiments, the intersection may occur perpendicularly. The second path may, for example, be aligned with a vertical axis. The connector cavity 302 may, for example, extend along the second path. This configuration may, for example, facilitate the alignment and securement of the connector 106 within the receiver 200. In some embodiments, the recess cavity 300 and the connector cavity 302 of a given receiver 200 may intersect at an angle other than perpendicular, including oblique angles, provided that the connector cavity 302 communicates with the recess cavity 300 so that an insert 306 received in the connector cavity 302 is accessible from the recess cavity 300. Although a perpendicular intersection is shown in the illustrated embodiments, the recess cavity 300 and connector cavity 302 need not be perpendicular in all embodiments.

The recess cavity 300 may, for example, be configured such that the bridge 304 of the connector 106 sits flush or below the top surface 308. In some embodiments, the sides of the recess cavity 300 may provide twisting resistance against the bridge 304. The twisting resistance may, for example, limit the rotational movement of the connector 106 relative to the transporter 104. In some examples, this configuration may advantageously limit skewing between adjacent transporters 104. Limiting skewing may, for example, enhance the stability of the container transport assembly 100. Enhanced stability may, for example, maintain a target alignment of the transporters 104 during operation.

A flush or sub-flush connector 106 is shown relative to the top surface 308 of the transporter 104. This configuration may, for example, provide a smooth and uninterrupted surface on the transporter 104. A flush or sub-flush connector 106 may, for example, reduce the risk of snagging or catching on external objects during transport. This may, for example, enhance the ease of maneuverability and handling of the transporter 104. Additionally, the flush or sub-flush positioning of the connector 106 may, for example, contribute to a more aesthetically pleasing design by maintaining a streamlined appearance.

In some embodiments, the connector 106 may be a separate, removable component that is distinct from each of the first transporter 104 and the second transporter 104. The connector 106 may not be carried by, hinged to, pivotally mounted to, slidably mounted to, permanently mounted to, or spring-biased from either the first transporter 104 or the second transporter 104. Instead, the connector 106 may be a stand-alone U-type coupler that is installed into, and removed from, the receivers 200 as a separate part. This separate, removable configuration may allow the connector 106 to be lowered from above adjacent transporters 104, retained by geometry of the receivers 200, and later withdrawn without disassembly of either transporter 104.

In some embodiments, each recess cavity 300 is open to the top surface 308 of the corresponding one of the first transporter 104 and the second transporter 104. Each connector cavity 302 may extend downwardly from the corresponding recess cavity 300. This upwardly-open configuration may allow the connector 106 to be installed by lowering the connector 106 from above the transporters 104, without requiring access to an underside of either transporter 104. In some embodiments, each receiver 200 may include a downward connector cavity 302 and an upper recess cavity 300, notch, or channel communicating with the connector cavity 302. The recess cavity 300 may be shallower than the connector cavity 302 and may define a seat for the bridge 304, while the connector cavity 302 receives one of the inserts 306. Such a two-level geometry, having a hole for the insert 306 and a notch for the bridge 304, may position the connector 106 flush or sub-flush relative to the top surface 308.

In some embodiments, opposing sidewalls of the recess cavity 300 may define bearing surfaces configured to contact, or closely receive, opposite sides of the bridge 304 when the connector 106 is installed. Contact between the bearing surfaces and the bridge 304 may resist yaw, twisting, skewing, racking, angular misalignment, lateral offset, or other relative rotation between adjacent transporters 104. Such resistance may be provided during pushing, pulling, turning, or movement of the transporters 104 across uneven surfaces. As used herein, skew and relative rotation may include, for example, yawing, twisting, racking, angular misalignment, or lateral offset of adjacent transporters 104 during pushing, pulling, turning, or crossing uneven surfaces.

In some embodiments, the bridge 304 may be dimensioned with clearance, an interference fit, a close fit, or a bearing engagement relative to the sidewalls of the recess cavity 300. Contact between the bridge 304 and the sidewalls may occur under load even where some clearance exists in an unloaded condition. Accordingly, the anti-skew engagement need not require constant physical contact in every embodiment. In some embodiments, resistance to relative rotation, skewing, or shear-load transfer as described herein may be characterized by contact between the recited bearing surfaces, sidewalls, or inserts 306 under an applied lateral, turning, or shear load of a magnitude typically encountered during pushing, pulling, or turning of loaded transporters 104. Such contact and resulting load transfer need not be present when the transporters 104 are unloaded and stationary.

In some embodiments, the downward-extending inserts 306 may engage sidewalls of the connector cavities 302 to transfer shear loads, lateral loads, pulling loads, pushing loads, and/or turning loads between adjacent transporters 104. Such shear-load transfer through the inserts 306 and connector cavities 302 may occur in addition to, or in cooperation with, any load sharing between the bridge 304 and the recess cavity 300. In this manner, the inserts 306 and the bridge 304 may cooperate to distribute forces between coupled transporters 104.

In some embodiments, the connector 106 may be installed and removed entirely from above the transporters 104. Installation and removal may occur while wheels 604 of the transporters 104 remain on a ground surface, and without lifting, inverting, or otherwise accessing underside surfaces of either transporter 104. In some embodiments, the connector 106 may be removed while one or more containers 102 remain supported on the transporters 104. Accordingly, the transporters 104 may be coupled, uncoupled, and reconfigured into different array arrangements without disturbing containers 102 supported thereon.

In some embodiments, flush or sub-flush positioning of the connector 106 may be measured relative to an adjacent upper surface, rim, load-supporting surface, or top plane surrounding the recess cavity 300. Sub-flush may mean that no portion of the connector 106 projects above such a surrounding surface, even where the recess cavity 300, connector cavity 302, or other local contours are present. This reference plane may accommodate embodiments in which the top surface 308 includes contours, walls, cavities, or recess rims.

In some embodiments, the connector 106 may enable rigid coupling between transporters 104 to form a predetermined array. The rigid coupling may, for example, allow the linked transporters 104 to form a “train” configuration that moves multiple stacks of containers 102 as a single unit. This train functionality may, for example, enhance efficiency by allowing a user to transport several container stacks simultaneously. The predetermined array may, for example, be configured in various arrangements depending on the number of transporters 104 and the spatial requirements of the environment.

In various embodiments, the inserts 306 of the connector 106 may be configured in different shapes. The inserts 306 may, for example, be cylindrical, rectangular, or tapered. Cylindrical inserts may, for example, provide ease of insertion and removal. Rectangular inserts may, for example, provide enhanced resistance to rotational movement. Tapered inserts may, for example, facilitate alignment during insertion and provide a secure fit within the connector cavity 302. The connector 106 may, for example, be constructed from various materials, such as metal, plastic, or composite materials, depending on the desired strength, weight, and cost considerations.

FIG. 4 depicts a cross-section of an example transport configuration. The inner wall 204 is depicted as a structural element that may, for example, define the boundary of an internal cavity (e.g., lower cavity 202). In some embodiments, the inner wall 204 may provide structural support to the overall system. The lower surface 400 of the bin is shown adjacent to the inner wall 204. In some examples, the inner wall 204 may be configured to matingly receive at least a portion of the lower surface 400 of the bin.

The upper surface 402 may, as shown, form a part of the bottom of storage bins. In this example, some or more of the outer wall 404 partially or completely matingly aligns with the upper surface 402 of the container. The outer wall 404 is illustrated as surrounding the upper surface 402. In some examples, the outer wall 404 may contribute to the containment and securement of storage bins within the transporter.

In some embodiments, the inner walls may be decorative. These decorative inner walls may, for example, enhance the aesthetic appeal of the system in environments where visual presentation is a consideration. In some embodiments, the outer walls may be decorative.

FIG. 5 and FIG. 6 depicts perspective views of an example transport. Some embodiments, such as shown, include ribs 600, for example. The ribs 600 may be configured, for example, are depicted as integral structural features. These features may, for example, provide reinforcement and/or stability to the overall framework. In some embodiments, the ribs 600 may be configured to enhance the load-bearing capacity of the system. Increased load capacity may, for example, be advantageous in supporting heavier storage bins.

The depicted embodiment includes wheel supports 602. The wheel support 602 may, for example, extend into the aperture 210, as shown. The wheel support 602 may, for example, facilitate the attachment and/or alignment of wheels 604. In various embodiments, the wheel support 602 may be designed to accommodate different wheel sizes or types. Wheel types and/or sizes may, for example, be selected based on specific mobility requirements (e.g., movement type, load capacity, surface characteristics).

In some embodiments, portions of the transporter 104 may include chamfered sections. The chamfered sections may, for example, be positioned at previously squared regions of the transporter 104. Chamfering may, for example, improve tensile strength of the transporter 104. In some examples, the chamfered sections may prevent bending under load. This configuration may, for example, enhance the structural integrity of the transporter 104 during transport operations involving heavier containers or multiple stacked containers.

In some embodiments, at least one transporter 104 may include a first pair of receivers 200 arranged along a longitudinal side of the transporter 104 and a second pair of receivers 200 arranged along a lateral side of the transporter 104. The same connector 106 may be selectively inserted into either pair of receivers 200, allowing transporters 104 to be coupled along the longitudinal axis 702, the lateral axis 700, or some combination thereof, to form linear, L-shaped, rectangular, grid, or other multi-axis arrays, such as the multi-axis transport array 704.

In some embodiments, a method of coupling and reconfiguring transporters 104 may include positioning the first transporter 104 adjacent the second transporter 104 such that a receiver 200 of the first transporter 104 is aligned with a receiver 200 of the second transporter 104; lowering the connector 106 from above the aligned receivers 200 such that the inserts 306 enter the connector cavities 302 and the bridge 304 seats flush or sub-flush within the recess cavities 300; positioning the bridge 304 such that it is laterally constrained by opposing sidewalls of the recess cavities 300; moving the linked transporters 104 as a train to transport containers 102; lifting the connector 106 upwardly out of the recess cavities 300 and connector cavities 302 while the transporters 104 remain supported on a ground surface; and repositioning at least one of the transporters 104 and reinserting the connector 106 into a different pair of receivers 200 to form a different array configuration.

FIG. 7 depicts an example multi-axis modular transport array. The multi-axis transport array 704 may, for example, configured to facilitate the movement and organization of storage bins. As shown, multiple transporters 104 are joined by connectors 106 in multiple axes to form a multi-axis transport array 704. Connectors 106 in longitudinal axis 702 join multiple transporters 104 longitudinally. Connectors 106 in a lateral axis 700 join multiple transporters 104 laterally. The lateral axis 700 and longitudinal axis 702 may, for example, intersect (e.g., perpendicularly).

An array of transporters linked together to form a single transporter may, for example, provide enhanced stability during transport. This configuration may, for example, reduce the likelihood of individual transporters shifting or tipping, which may enhance the safety of the transported items. In some embodiments, the linked transporters may, for example, facilitate the movement of larger or heavier loads by distributing the weight across multiple units. This distribution may, for example, reduce the strain on individual transporters, potentially extending their operational lifespan.

The linked array may, for example, allow for increased transport capacity by combining the storage capabilities of multiple transporters. This may, for example, enable the efficient relocation of multiple storage bins simultaneously, which may improve operational efficiency in environments such as warehouses or retail settings. In some examples, the modular nature of the linked transporters may, for example, provide flexibility in configuring the transport system to accommodate varying storage needs. This flexibility may, for example, allow users to adapt the system to different spatial constraints or organizational requirements.

The interconnected transporters may, for example, provide a streamlined and cohesive appearance, which may be advantageous in environments where visual presentation is a consideration. The unified structure may, for example, facilitate easier maneuverability and handling, as the transporters move as a single unit. This may, for example, reduce the complexity of navigating through tight spaces or around obstacles, enhancing the overall usability of the transport system.

FIG. 8, FIG. 9, FIG. 10, FIG. 11, FIG. 12, FIG. 13, FIG. 15, and FIG. 14 depict example embodiments related to transport handles. Turning to FIG. 8, the figure illustrates a transporter 104. The transporter 104 includes a handle 800. The handle 800 is connected to a frame 804. The frame 804 includes, in this example, uprights coupling the grip 808 to the transporter 104 via the coupler 806.

In this example, the frame 804 is supported by a frame member 802. As shown, the frame member 802 is configured as a cross-piece. For example, the frame member 802 may stiffen the frame 804. The frame member 802 is coupled, in the depicted example, by fasteners (e.g., bolts).

The frame member 802 is attached to a coupler 806. The coupler 806 joins the handle 800 to the transporter 104. The coupler 806 is shown capturing opposing corners. The corner configuration may, for example, advantageously directly transfer forces during turning motions to the side of the transporter 104. In some embodiments, the coupler 806 may be configured to engage two corners of the transporter 104 positioned along a common edge or side of the transporter 104, such that the coupler 806 spans substantially the width of that side. In other embodiments, the coupler 806 may be configured to engage diagonally opposite corners of the transporter 104 across the full footprint of the transporter 104.

FIG. 9 depicts a handle 800 having a frame 804 that extends from the coupler 806 along a first axis before turning upwards along a second axis intersecting the first axis. A side view 901 and a front view 902 are depicted.

FIG. 10 depicts a handle 800 having a frame 804 that extends upwards from the coupler 806 along a first axis before turning outwards along a second axis intersecting the first axis. A side view 1001 and a front view 1002 are depicted.

FIG. 11 depicts a handle 800 having a frame 804 that extends from the coupler 806 along a single axis to the grip 808. In this example, the grip 808 extends outwards in multiple (e.g., opposing) directions from the frame 804. The frame 804 in this example includes a single vertical member extending from the coupler 806. A side view 1101 and a front view 1102 are depicted.

FIG. 12 depicts an example in which a frame 804 single longitudinal (e.g., ‘vertical’) frame member is offset to one side of a center of the transporter 104. The grip 808 extends further to one side (e.g., left, as shown) of the frame 804. A side view 1201 and a front view 1202 are depicted.

FIG. 13 depicts a handle 800 coupled to the transporter 104 by a retainer 1300 coupling the coupler 806 to the transporter 104. The retainer 1300 may, for example, include a bolt. Other fasteners (e.g., pins) may, for example, be used.

Also depicted in this example is a frame stiffener 1302. The frame stiffener 1302 may, for example, advantageously enhance rigidity of the frame 804. Depicted are a side view 1303 and a perspective view 1304.

In some embodiments, the upper hook feature and the lower hook feature of the coupler 806 may cooperate to form a clamp-like load path, such that pulling, pushing, lifting, or turning forces applied to the grip 808 are transferred through the coupler 806 into upper and underside bearing regions of the transporter 104. The clamp-like engagement of the upper hook feature over an upper surface and the lower hook feature under an underside of the transporter 104 may resist separation forces during movement operations.

In some embodiments, the coupler 806 may bridge or clamp across a plurality of transporters 104. For example, the coupler 806 may cooperate with, or be positioned adjacent to, a connector 106 joining adjacent transporters 104 in a multi-axis transport array 704, such that forces applied to the grip 808 are distributed across the array 704. In some embodiments, the coupler 806 may be attached across adjacent transporters 104 to couple the transporters 104 together and to apply forces to the multi-axis transport array 704.

FIG. 14 illustrates a perspective view 1401 of a handle 800. The handle 800 is shown with a coupler 806 configured to engage features of the transporter 104. As shown, the coupler 806 is provided with a hook feature configured to engage an underside of the transporter. Such embodiments may, for example, advantageously engage the transporter to apply translation forces directly to the transporter. In some embodiments, as shown, the handle 800 may include, for example, a side view 1402. A close-up view 1403 of the engagement between the coupler 806 and the transporter 104 may, for example, illustrate a lower hook 1404 and an upper hook 1406. In some embodiments, as depicted, the lower hook 1404 and the upper hook 1406 may form part of the coupler 806. A wall 1408 of the transporter 104 may, for example, be engaged by the lower hook 1404 and/or the upper hook 1406 (as shown).

In this example, the coupler 806 is also retained to the transporter 104 by retainers 1300. Some embodiments may, for example, be retainerless and/or have integrated retainers (e.g., having hooks configured to engage upper and lower surfaces).

FIG. 15 shows a multi-axis transport array 704. The multi-axis transport array 704 includes multiple transporters 104. Transporters 104 may, for example, be connected by one or more connectors 106, as shown on the left of the figure.

In this example, a first handle 800 (on the left of FIG. 15) is shown coupled to the multi-axis transport array 704 by a connector 106. The coupler 806 may, as depicted, be coupled (e.g., additionally) by retainer 1300. In this example, the handle 800 is simultaneously coupled to multiple transporters 104. In some examples, the handle 800 may be coupled to a single transporter 104. As shown, the multi-axis transport array 704 may be provided with multiple handles.

Some embodiments may include an adjustable handle (e.g., field-adjustable), as shown by the handle on the right of the array. A field adjustable handle 800 may, for example, include an adjustable width. This adjustable width may, for example, allow the handle to accommodate various user preferences or storage bin sizes.

In some embodiments, the handle may be provided with expansion inserts, as shown in FIG. 15. Expansion inserts may, for example, include interchangeable frame members 802 and/or grips 808. The interchangeable members may, for example, allow for quick customization of the handle's dimensions, which may advantageously enable adaptation of a handle to an multi-axis transport array 704 (e.g., a field-assembled array).

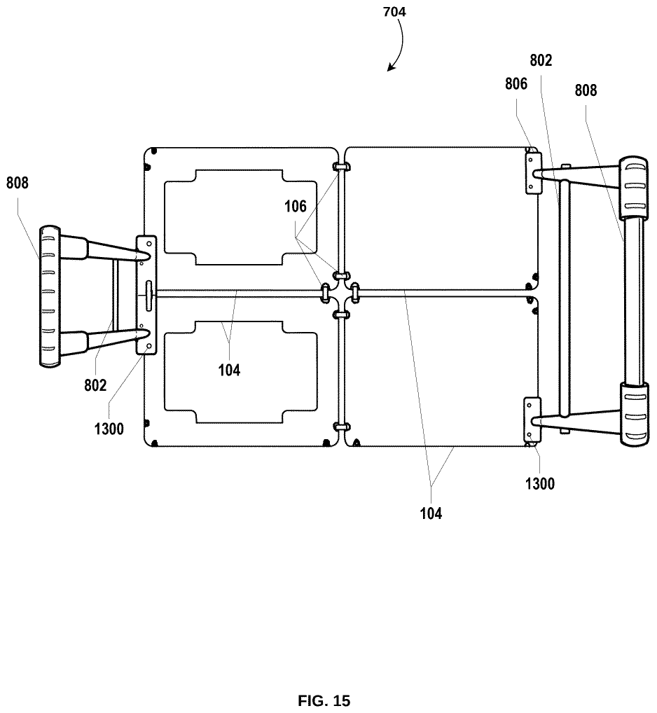

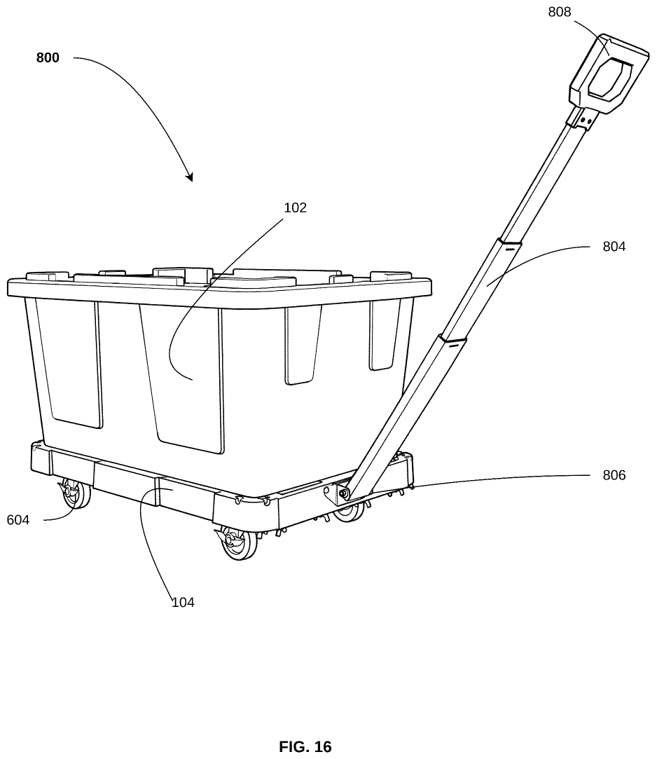

FIG. 16 depicts a container 102 positioned on a transporter 104 with a handle 800 coupled thereto. The handle 800 includes a frame 804 extending from a coupler 806 at a corner of the transporter 104 to a grip 808 at the upper end. Wheels 604 are positioned at the corners of the transporter 104. In some embodiments, the handle 800 may be removable, which may allow for selective attachment and detachment of the handle 800 from the transporter 104. The removable nature of the handle 800 may, for example, provide flexibility in configuring the transporter 104 for different use scenarios.

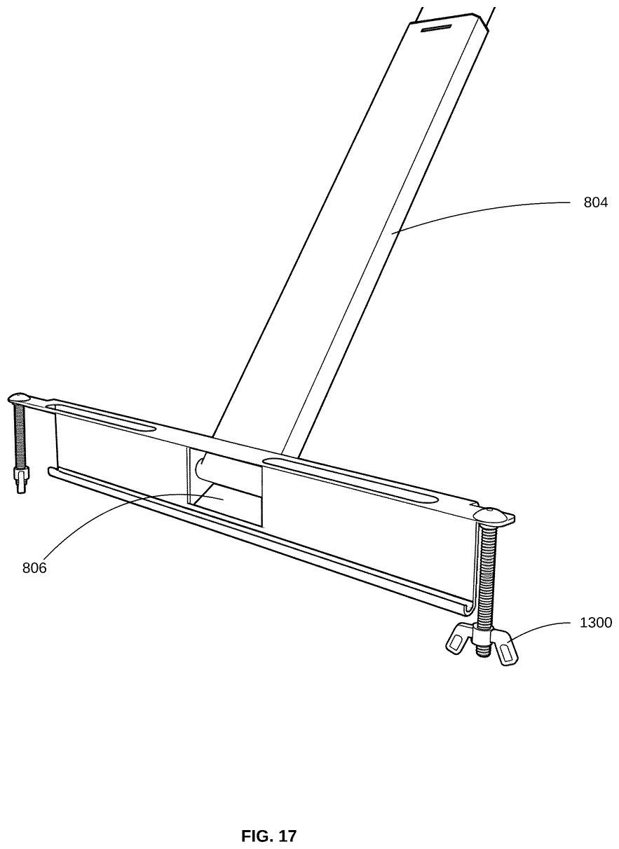

FIG. 17 depicts a detail view of a coupler 806 configured for attachment to a transporter. The coupler 806 includes a cross-member that spans across a portion of the transporter, with retainers 1300 at each end. A frame 804 extends upwardly from the coupler 806. The retainers 1300 may, for example, secure the connection between the coupler 806 and the transporter 104, which may enhance stability during transport operations. In some embodiments, the retainers 1300 may provide a secure attachment that resists unintentional disconnection while still allowing for intentional removal of the handle 800.

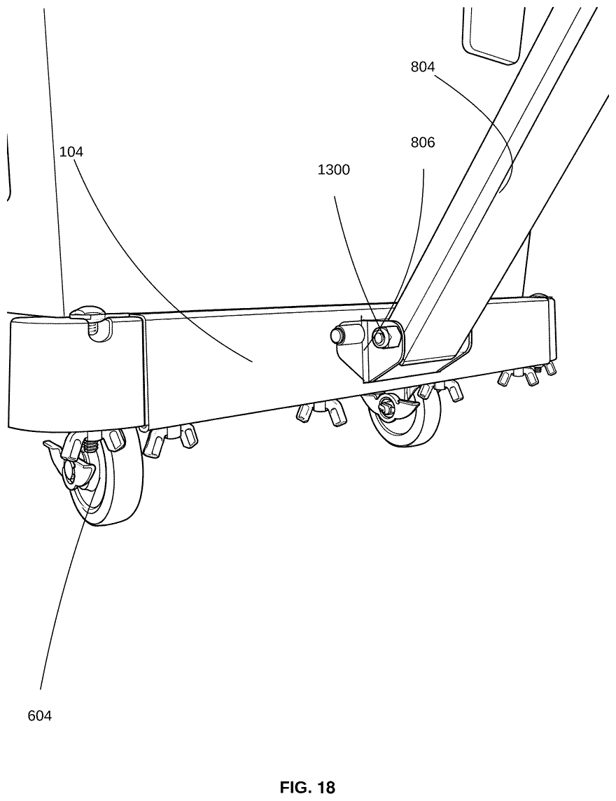

FIG. 18 depicts a detail view of a handle attachment to a transporter 104. A frame 804 extends downward to a coupler 806 that engages a corner region of the transporter 104. A retainer 1300 secures the frame 804 to the coupler 806. Wheels 604 are mounted at corners of the transporter 104. The coupler 806 may, for example, include hook features configured to engage both an upper surface and an underside of the transporter 104. This dual engagement may, for example, allow forces applied to the handle 800 to be transferred directly to the transporter 104. The retainer 1300 may, for example, provide additional securement to maintain the connection during use. In some embodiments, the handle 800 may be removable from the transporter 104, which may allow for reconfiguration or storage of the handle 800 separately from the transporter 104.

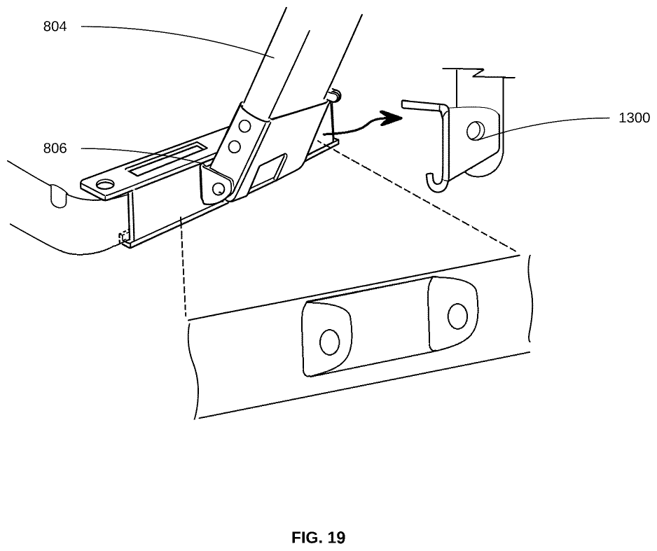

FIG. 19 depicts a detail view of a coupler 806 hook mechanism. The coupler 806 includes a hook component configured to engage an underside of the transporter. The figure shows the frame 804 extending upwardly from the coupler 806, with a retainer 1300 securing the connection. A magnified detail view shows mounting apertures in the transporter rail configured to receive the coupler 806 hooks. The hook mechanism may, for example, engage both under and over the transporter 104, which may allow translation forces to be transferred directly to the transporter 104 during movement operations. This configuration may, for example, provide a secure mechanical connection that resists separation forces during transport.

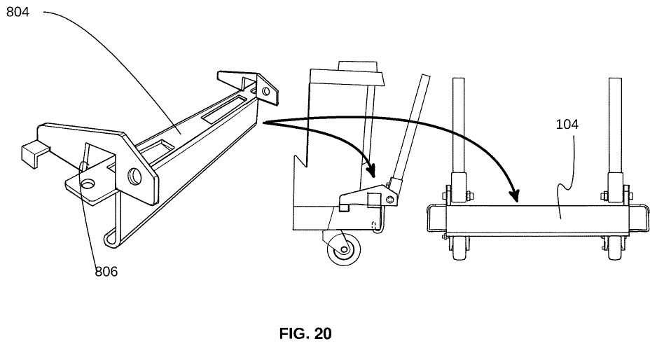

FIG. 20 depicts a folding handle configuration. The figure illustrates the handle in multiple positions: a deployed position with the frame 804 extending upwardly from the coupler 806, an intermediate folding position with the frame 804 rotating toward a stowed position, and a fully stowed configuration with the frame 804 folded downward alongside the transporter 104. This folding capability may, for example, allow the handle 800 to fold flat against or alongside the transporter 104. The ability to fold flat may, for example, facilitate compact storage of the handle 800 when not in use and may reduce the overall profile of the transporter 104 during transport or storage. In some embodiments, the folding configuration may allow multiple transporters 104 with handles 800 to be stacked or stored in a reduced footprint.

In some embodiments, the folding mechanism of the handle 800 may include a pivot joint, hinge, or quick-release pivot. The pivot joint may, for example, allow the frame 804 to rotate between the deployed and stowed positions. A hinge mechanism may, for example, provide a defined axis of rotation for the folding action. A quick-release pivot may, for example, allow for rapid transition between deployed and stowed configurations. In the stowed position, the handle 800 may, for example, be substantially parallel to a surface of the transporter 104. This substantially parallel orientation may, for example, minimize the vertical profile of the handle 800 when stowed, which may facilitate stacking or storage of the transporter 104.

In some embodiments, the handle may include telescoping frame members 802 and/or grips 808. The telescoping members may, for example, enable the handle to extend or retract smoothly. This feature may provide flexibility in handle width, which may be beneficial in environments where space constraints or user ergonomics are considerations.

In some embodiments, a first telescoping member may be configured to adjust an overall width of the handle system 800, for example by extending or retracting a cross member or frame member 802 spanning between opposing sides of the frame 804. In other embodiments, a second, independent telescoping member may be configured to adjust a distance between the grip 808 and the transporter 104, for example by extending or retracting an upright portion of the frame 804. These telescoping functions may be provided individually or in combination in a given embodiment.

In some embodiments, a handle bracket forming part of the coupler 806 may include a lower lip or hook configured to hook beneath a lower surface of the transporter 104, an upright portion configured to bear against a front or side face of the transporter 104, and an upper portion configured to bear against an upper surface of the transporter 104. A retainer 1300, such as a bolt, pin, screw, latch, or other fastener, may extend through a connector hole, joiner hole, or other aperture of the transporter 104, including a connector cavity 302 or recess cavity 300 otherwise used to receive a connector 106, to secure the handle bracket. In some embodiments, one or more slots, openings, or relief regions in the handle bracket may preserve access to a stored connector 106, joiner hole, or receiver 200, such that the handle system 800 may be mounted on either side of the transporter 104.

In some embodiments, the handle system 800 may be center-mounted, side-mounted, corner-mounted, or coupled across opposing corners of the transporter 104. A center-mounted handle system 800 may provide balanced pulling forces, while a side-mounted or corner-mounted handle system 800 may provide increased turning leverage. In some embodiments, corner mounting may improve maneuverability under heavy loads, including loads of approximately 250 to 350 pounds, or on rough surfaces such as asphalt, by allowing a user to apply turning forces near a corner of the transporter 104, which may assist in reorienting the wheels 604 during turning.

In some embodiments, the frame 804 may extend across substantially an entire width of the transporter 104. The frame 804 may include a transverse axle, a cross member, or a pair of spaced downward tubes coupled to spaced regions of the transporter 104. A full-width handle connection may increase steering rigidity by distributing turning forces across the width of the transporter 104.

In some embodiments, the frame 804 may include a two-post, hand-truck-style configuration having two spaced upright members extending from the coupler 806 to the grip 808. The spaced upright members may improve lateral stiffness and load control during pushing, pulling, or turning of the transporter 104.

In some embodiments, the frame 804 may include a telescoping handle member, including a separately manufactured or commercially available telescoping handle retrofitted to the transporter 104 by the coupler 806. The coupler 806 may adapt the telescoping handle to the transporter 104 without modification of a body of the transporter 104.

In some embodiments, the handle system 800 may include expansion inserts, interchangeable frame members 802, telescoping cross members, or modular grips 808 that allow a width of the handle system 800 to be adjusted for a single transporter 104 or for a multi-axis transport array 704 of multiple transporters 104.

In some embodiments, the frame 804 may rotate through approximately 180 degrees between a deployed position and a folded position, in which the frame 804 lies along, on top of, or adjacent to the transporter 104. A notch, recess, relief region, clearance region, fixed bend, or secondary pivot may be provided in the transporter 104, the coupler 806, or the frame 804 to allow the frame 804 to clear an obstruction and fold substantially flat. In some embodiments, the frame 804 may be lifted or translated relative to the coupler 806 before folding downward into the stowed position. In some embodiments, the frame 804 may include a fixed bend, curved portion, or secondary pivot so that the frame 804 may fold or nest relative to the transporter 104 while maintaining an ergonomic deployed orientation.

Although certain embodiments described herein use a separate, top-inserted U-type coupler as the connector 106, other embodiments may employ alternate joiner mechanisms. For example, the connector 106 may include an injection-molded joiner, a hinged joiner, a horizontally hinged connector, a pivoting bridge, a sliding connector, a latch, or a snap-fit member that is selectively movable between a stored position and a deployed position. Such alternate joiners may couple adjacent transporters 104 along the longitudinal axis 702, the lateral axis 700, or both.

In some embodiments, the transporter 104 may include wheels 604, casters, skids, low-friction pads, sliders, or combinations thereof, and may be moved using a pulling member, rope, strap, or the handle system 800 described herein. In some embodiments, the transporter 104 may be configured to slide across a support surface using a rope or strap, and may additionally or alternatively include wheels 604 to reduce friction during movement.

Some embodiments may have an appearance as depicted and described in U.S. design patent application Ser. No. 30/003,944, filed May 15, 2025 (naming inventor(s) including RODEBAUGH, Noah Michael) and titled “Container Transporter,” the entire contents of which are incorporated herein by reference.

Although example embodiments have been shown and described with respect to the figures, other embodiments are contemplated. In some embodiments, transporters may be used in the logistics industry. This may, for example, facilitate the efficient movement of goods within distribution centers.

In some embodiments, transporters may be utilized in the healthcare industry. This may, for example, assist in the organized transport of medical supplies and equipment within hospital facilities.

In some embodiments, transporters may be applied in the automotive industry. This may, for example, support the movement of parts and components within manufacturing plants.

In some embodiments, transporters may be employed in the food and beverage industry. This may, for example, aid in the transportation of ingredients and packaged goods within processing and storage facilities.

In some embodiments, transporters may be configured into the retail industry. This may, for example, enhance the organization and movement of inventory within warehouses and retail outlets.

In some embodiments, a transporter (e.g., bin dolly) system may include connectors configured in various shapes, such as circular, square, and/or triangular (e.g., cross-sectional shape of the connector). These shapes may, for example, provide different levels of stability and ease of connection, depending on the specific application requirements. Circular connectors may, for example, allow for smooth rotational movement, which may be advantageous in dynamic storage environments.

In some embodiments, the connectors may be designed as multi-axis connectors. These connectors may, for example, allow for movement and connection along multiple axes, such as horizontal and vertical. This multi-axis capability may, for example, enable more complex and flexible configurations, which may be beneficial in environments requiring adaptable storage solutions.

In some embodiments, the connectors 106 may include a locking mechanism. A pin-based locking mechanism may, for example, be used to secure the connection between multiple dollies. In some examples, a latch-based locking mechanism may be employed to prevent unintentional disconnection. The locking feature may, for example, enhance the stability and safety of the storage system during transport.

In some examples, connectors 106 may be designed with a quick-release feature. A pull handle may, for example, be included in some examples. The inclusion of a pull handle may, for example, facilitate ease of use during assembly and disassembly. In some examples, a spring-loaded ball may be incorporated. The use of a spring-loaded ball may, for example, provide secure engagement while allowing for rapid release. Some examples may include a detent mechanism. A detent mechanism may, for example, enhance the stability of the connection during use. This feature may, for example, allow for rapid assembly and disassembly of the dolly system. Quick-release connectors may, for example, be advantageous in scenarios where frequent reconfiguration of the storage system is required.

Connectors may be constructed from various materials, such as metal, plastic, and/or composite materials. Metal connectors may, for example, provide enhanced durability and strength, which may be beneficial in heavy-duty applications. Plastic connectors may, for example, offer an easily manufactured and/or cost-effective solution, which may be suitable for budget-conscious environments. Composite material connectors may, for example, combine benefits of both metal and polymers, providing a balance of strength and flexibility.

In various embodiments, the multi-axis transport array 704 may be constructed from different materials, such as wire or plastic. The choice of material may, for example, affect the durability, weight, and cost-effectiveness of the system. For instance, wire materials may provide a lightweight and durable solution, which may be beneficial in environments where ease of handling is prioritized. Alternatively, plastic materials may offer a cost-effective option while maintaining essential functionality, which may be advantageous in budget-conscious applications.

In some embodiments, the handle may be equipped with one or more grips 808. The grips 808 may, for example, be interchangeable to provide different textures or materials for user comfort. This may enhance the user's grip and control over the handle, which may be advantageous during transport of storage bins.

In some embodiments, the handle may include telescoping grips 808. The telescoping grips 806 may, for example, allow for adjustment in grip length or position. This may provide additional ergonomic benefits, which may be useful in reducing user fatigue during extended use.

In some embodiments, transporter systems may include handles with a straight configuration. This design may, for example, provide a simple and ergonomic grip for users, potentially enhancing ease of use during transport.

In some examples, the handles may have a curved shape. This curvature may, for example, conform to the natural grip of a user's hand, which may improve comfort and reduce strain during prolonged use.

Various embodiments may include handles with an angled design. This angle may, for example, facilitate leverage and control when maneuvering the dolly, which may be advantageous in navigating tight spaces.

In some embodiments, the handles may be designed with a telescopic feature. This telescopic capability may, for example, allow users to adjust the handle length to suit their height or preference, which may enhance user comfort and adaptability.

In some embodiments, the handles may incorporate a textured surface. This texture may, for example, provide a non-slip grip, which may improve safety and control during transport in various conditions.

In some embodiments, transporter 104 may include a motorized transporter. The motorized transporter may, for example, facilitate the movement of storage bins with reduced manual effort. This may be advantageous in environments where efficiency and speed of transport are prioritized.

In various embodiments, the motor associated with the transporter may be modular. The modularity of the motor may, for example, allow for easy replacement or upgrading of the motor unit. This may provide flexibility in maintaining or enhancing the system's performance over time.

In certain embodiments, the motor may be field coupled via connectors 106. The use of connectors may, for example, enable quick and efficient attachment or detachment of the motor from the transporter. This feature may be beneficial in scenarios where rapid reconfiguration and/or maintenance is required.

In some embodiments, a transporter 104 and/or array of transporters may, for example, include walls. These walls may, for example, provide additional structural support and containment for the storage bins. The presence of walls may, for example, advantageously enhance the stability of the bins during transport.

In some embodiments, walls may, for example, be field-coupled. This field coupling may, for example, be achieved through the use of connectors. The use of connectors 106 may, for example, advantageously provide easy assembly and/or disassembly of the walls, which may, for example, provide flexibility in configuring the dolly system according to specific user requirements.

In some embodiments, a container transport system may include a first transporter and a second transporter, each configured to support a container. The first transporter may include a first receiver and the second transporter may include a second receiver. Each of the first receiver and the second receiver may include a recess cavity and a connector cavity, with the recess cavity extending along a first path and the connector cavity extending along a second path intersecting the first path. A connector may be configured as a U-type coupler and may include a bridge linking two downward-extending inserts. The inserts may be configured for top-insertion from above the first transporter and the second transporter into the connector cavities of the first receiver and the second receiver. The bridge may be positioned within the recess cavities such that an uppermost surface of the connector is flush or sub-flush with a top surface of the first transporter and the second transporter. In some examples, the connector may enable rigid coupling between the first transporter and the second transporter to form a predetermined array, allowing the transporters to form a train configuration that moves multiple stacks of containers as a single unit. The inserts may be cylindrical, rectangular, or tapered. In some embodiments, the connector may include a locking mechanism configured to secure the connection between the first transporter and the second transporter. In some examples, the connector may include a quick-release feature configured to allow rapid assembly and disassembly of the first transporter and the second transporter.

In some embodiments, a method for transporting containers may include positioning a first transporter adjacent to a second transporter, where each of the first transporter and the second transporter includes a receiver having a recess cavity and a connector cavity. The method may include top-inserting a U-type connector from above the first transporter and the second transporter. The U-type connector may include a bridge linking two downward-extending inserts, and the inserts may be inserted into the connector cavities of the first transporter and the second transporter. The bridge may be positioned within the recess cavities such that an uppermost surface of the U-type connector is flush or sub-flush with a top surface of the first transporter and the second transporter. The method may include moving the first transporter and the second transporter as a linked train to transport containers supported by the first transporter and the second transporter. In some examples, the method may include coupling a third transporter to the first transporter along a lateral axis to form a multi-axis transport array, with the first transporter and the second transporter coupled along a longitudinal axis. In some embodiments, the method may include adjusting a configuration of the first transporter and the second transporter to fit through a narrow passage. The method may also include releasing the U-type connector from the first transporter and the second transporter by lifting the U-type connector upwardly from the recess cavities and the connector cavities, and reconfiguring the first transporter and the second transporter into a different array arrangement after releasing the U-type connector.

In some embodiments, a handle system for a wheeled transporter may include a frame extending from a lower end to an upper end, with the upper end including a grip. A coupler may be disposed at the lower end of the frame and may include hook features configured to engage both an upper surface and an underside of the wheeled transporter. In some embodiments, a lower hook feature of the coupler may be configured to hook beneath, engage beneath, or extend beneath a lower surface of the wheeled transporter without penetrating or being inserted into the underside surface itself. The lower hook feature may, for example, be received in a gap, channel, lip, or recessed underside region of the wheeled transporter, or may simply bear against the underside surface from below. The hook features may allow forces applied to the grip to be transferred directly to the container transporter. A retainer may be configured to secure the coupler to the container transporter. The frame may be foldable between a deployed position and a stowed position, and in the stowed position the frame may be substantially parallel to a surface of the container transporter. In some examples, the handle system may be removable from the container transporter. The frame may be foldable via a pivot joint, a hinge, or a quick-release pivot. In some embodiments, the frame may include a telescoping member configured to adjust a width of the handle system. The grip may be interchangeable to provide different textures or materials. In some examples, the coupler may be configured to couple the handle system to a multi-axis transport array including a plurality of transporters connected by connectors.

As used in the claims, comprising and consisting are used in the United States open-ended and closed-ended sense, respectively.

It will be understood that various modifications can be made within the scope of this disclosure. Embodiments depict illustrative combinations of disclosed features, components, and/or steps. Any combination of disclosed features is expressly contemplated unless specifically excluded or required by the context. For example, one or more advantageously results may be achieved if components are removed, added, multiplied, scaled, and/or rearranged, and/or if steps in a method are omitted, added, repeated, and/or performed in a different order. Therefore, other implementations are contemplated within the scope of the claims.

What is claimed is:

1. A container transport system comprising:
a first transporter configured to support a container, the first transporter including a first receiver;
a second transporter configured to support a container, the second transporter including a second receiver, wherein each of the first receiver and the second receiver includes a recess cavity and a connector cavity, the recess cavity extending along a first path and the connector cavity extending along a second path intersecting the first path; and
a connector configured as a U-type coupler, the connector including a bridge linking two downward-extending inserts, wherein the inserts are configured for top-insertion from above the first transporter and the second transporter into the connector cavities of the first receiver and the second receiver, and wherein the bridge is positioned within the recess cavities such that an uppermost surface of the connector is flush or sub-flush with a top surface of the first transporter and the second transporter.

2. The container transport system of claim 1, wherein each of the recess cavities is open to the top surface of the corresponding one of the first transporter and the second transporter, and wherein each of the connector cavities extends downwardly from the corresponding recess cavity.

3. The container transport system of claim 1, wherein the connector is a separate, removable component from the first transporter and the second transporter.

4. The container transport system of claim 1, wherein, when coupling the first transporter and the second transporter, the bridge is laterally constrained by opposing sidewalls of the recess cavities such that relative rotation is resisted between the first transporter and the second transporter.

5. The container transport system of claim 1, wherein the recess cavities of the first receiver and the second receiver define opposed bearing surfaces that contact opposite sides of the bridge when the connector is installed, and wherein the opposed bearing surfaces limit lateral skewing between the first transporter and the second transporter during movement of the first transporter and the second transporter.

6. The container transport system of claim 1, wherein the downward-extending inserts engage sidewalls of the connector cavities such that shear loads are transferred between the first transporter and the second transporter.

7. The container transport system of claim 1, wherein the connector is removable from the first transporter and the second transporter by upward movement of the connector from the recess cavities and the connector cavities without accessing underside surfaces of the first transporter or the second transporter.

8. The container transport system of claim 1, wherein at least one of the first transporter and the second transporter includes a first pair of receivers arranged along a longitudinal side and a second pair of receivers arranged along a lateral side, such that the connector is selectively insertable to couple transporters along a longitudinal axis, a lateral axis, or some combination thereof.

9. A method of transporting containers, the method comprising:
positioning a first transporter adjacent to a second transporter, wherein each of the first transporter and the second transporter includes a receiver having a recess cavity and a connector cavity;
inserting a U-type connector from a top of the first transporter and the second transporter, the U-type connector including a bridge linking two downward-extending inserts, wherein the inserts are inserted into the connector cavities of the first transporter and the second transporter, and wherein the bridge is positioned within the recess cavities such that an uppermost surface of the U-type connector is flush or sub-flush with a top surface of the first transporter and the second transporter; and
moving the first transporter and the second transporter as a linked train such that containers supported by the first transporter and containers supported by the second transporter are transported.

10. The method of claim 9, wherein inserting the U-type connector comprises lowering the U-type connector from above the first transporter and the second transporter such that the inserts enter the connector cavities and the bridge seats within the recess cavities without accessing underside surfaces of the first transporter or the second transporter.

11. The method of claim 9, further comprising positioning the bridge constrained within the recess cavities by opposing sidewalls of the recess cavities such that skewing is resisted between the first transporter and the second transporter during movement of the linked train.

12. The method of claim 9, further comprising releasing the U-type connector from the first transporter and the second transporter by lifting the U-type connector upwardly from the recess cavities and the connector cavities while the first transporter and the second transporter remain supported on a ground surface.

13. The method of claim 12, further comprising, after releasing the U-type connector, repositioning at least one of the first transporter and the second transporter and reinserting the U-type connector into a different pair of receivers such that a different transporter-array configuration is formed.

14. A container transport system comprising:
a wheeled transporter configured to receive a stack of storage bins in a recess and to support and laterally transport the stack of storage bins across a ground surface;
a handle system coupled to an edge of the wheeled transporter, the handle system comprising:
a frame extending from a lower end to an upper end, the upper end comprising a grip;
a coupler disposed at the lower end of the frame, the coupler comprising:
a lower hook feature configured to be hooked beneath an underside of the wheeled transporter; and
an upper hook feature configured to extend over an upper surface of the wheeled transporter, wherein the upper hook feature and the lower hook feature are configured to transfer forces applied to the grip to the wheeled transporter; and
a retainer configured to secure the coupler to the wheeled transporter.

15. The container transport system of claim 14, wherein the handle system is selectively removable from the wheeled transporter.

16. The container transport system of claim 14, wherein the frame is foldably coupled to the coupler via a pivot joint.

17. The container transport system of claim 14, wherein the frame comprises a telescoping member configured to adjust a width of the handle system.

18. The container transport system of claim 14, wherein the frame comprises a telescoping member configured to adjust a distance from the grip to the wheeled transporter.

19. The container transport system of claim 14, wherein the coupler is configured to engage two corners of the wheeled transporter positioned along a common edge of the wheeled transporter.

20. The container transport system of claim 14, wherein the coupler is further configured to cooperate with a connector joining the wheeled transporter to a second wheeled transporter such that a multi-axis transport array is formed configured to support a plurality of stacks of storage bins.
